(19) United States
(12) Patent Application Publication
(10) Pub. No.: US 2019/0186116 A1
(43) Pub. Date: Jun. 20, 2019

(54) Wash And Clean Apparatus

(71) Applicant: Brian Schwab, East Chatham, NY (US)

(72) Inventor: Brian Schwab, East Chatham, NY (US)

(21) Appl. No.: 15/847,594

(22) Filed: Dec. 19, 2017

(51) Int. Cl. E03D 9/08; B05B 1/02; B05B 12/00

(52) U.S. Cl. CPC E03D 9/08; B05B 12/002; B05B 15/061; B05B 1/02

(57) ABSTRACT

A method and apparatus is provided for washing and cleaning a region of a human body with easy to carry, easy to be connected to auxiliary parts, and easy to install and use functions. The apparatus includes a support body, an extended element connected to the support body, a lip element connected to the extended element, and a spray wand assembly connected to the lip element and adapted to deliver liquid with one or more liquid channels therein, wherein the spray wand assembly, includes a distal end element where a spray opening is located.

### BACKGROUND OF THE INVENTION

Embodiments of the present invention generally relate to apparatus for washing and cleaning a region of a human body. More specifically, aspects of the present invention provide a method and apparatus for delivering and applying water, medication, and/or a cleaning solution to a region of the body (e.g., genital or anal area, intimate parts, perianal region) which may be difficult for the user to access

### DESCRIPTION OF THE RELATED ART

Bidets and other modern toilet seat systems have been used to spray water and clean private parts of a user using a toilet. The bidet systems are used for washing the genital and anal areas using cleaning water of appropriate temperature sprayed from the center of the bidet system, instead of a toilet paper after relief stool or urination. Originally being developed for washing the pubic area for females, bidet systems have has now been popular among people of all ages and both sexes because it is known to be more hygienic to wash the intimate parts and anus with water instead of paper after relief. In addition, cleansing the pubic/anal regions with water may help to avoid infection and prevent hemorrhoids and other anal disease. Furthermore, it is very effective for women with gynecology diseases. It is also very useful for the elderly or obese people to relieve themselves with great convenience.

However, most bidets and bidet seat cleaning systems have water spray nozzle located to be positioned near posterior or anal area and thus not suitable for washing and cleaning female anterior private parts. In addition, bidet systems are expensive and need to be pre-installed. Further, many public restrooms have not yet and may not have such water spray bidet systems. Therefore, there is a need for a convenient, easy to carry wash and clean apparatus for cleaning genital or anal area of a human body.

### SUMMARY OF THE INVENTION

The present invention generally a small-scale apparatus for washing and cleaning genital and anal area of a human body. An apparatus and method of using the apparatus are provided for washing and cleaning a region of a human body with easy to carry, easy to be connected to auxiliary parts, and easy to install and use functions.

In one embodiment, the wash and clean apparatus generally includes a support body, an extended element connected to the support body, a lip element connected to the extended element, and a spray wand assembly connected to the lip element and adapted to deliver liquids with one or more liquid channels therein, wherein the spray wand assembly, includes a distal end element where a spray opening is located. In another embodiment, the spray wand assembly of the apparatus is adapted to deliver liquids flowing therein to be sprayed out, via the spray opening, and onto a desirable area (e.g., a genital area) of a human body.

In a further embodiment, the spray wand assembly of the apparatus includes an arm element and a connector, where the connector is adapted to rotate the arm element such that the spray opening on the distant end element can be flexibly adjusted to be close to a desirable area. In one aspect, the spray wand assembly further includes a rod element, where the connector is adapted to connect the rod element and the arm element. In anther aspect, the arm element of the spray wand assembly is connected to the distal end element.

In addition, the wash and clean apparatus may further include a power switch, a power indicator for powering up the apparatus and operating wash, clean and other functions of the apparatus. In one aspect, the apparatus is connected to a power cord. In another aspect, the apparatus is connected to a battery power pack.

In still another embodiment, the support body of the apparatus is connected to a canister assembly, which may include medication and/or cleaner solutions therein. In yet another embodiment, the support body of the apparatus includes a water inlet adapted to be connected to a water hose assembly for supplying water and other liquid into the wash and clean apparatus.

In one aspect, the extended element of the apparatus includes a lever. In another aspect, the extended element of the apparatus includes a suction cup assembly therein. The lever and the suction cup assembly are designed so as to allow the wash and clean apparatus to be easily placed and secured onto a toilet.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of a washing and cleaning apparatus according to an embodiment of the invention.

FIG. 2 is a perspective view of a washing and cleaning apparatus and a toilet seat apparatus according to one embodiment of the invention.

FIG. 3A is a front view of operating a washing and cleaning apparatus according to one embodiment of the invention.

FIG. 3B is a front view of operating a washing and cleaning apparatus according to another embodiment of the invention.

FIG. 3C is a front view of operating a washing and cleaning apparatus according to still another embodiment of the invention.

FIG. 3D is a front view of operating a washing and cleaning apparatus according to yet another embodiment of the invention.

FIG. 4 is a perspective view of a washing and cleaning apparatus according to another embodiment of the invention.

### DETAILED DESCRIPTION

The present invention includes An apparatus for providing easy washing and cleaning of a person's bottom while using a toilet is provided. The apparatus can be placed directly over a rim of a toilet bowl or a seat of a toilet seat system.

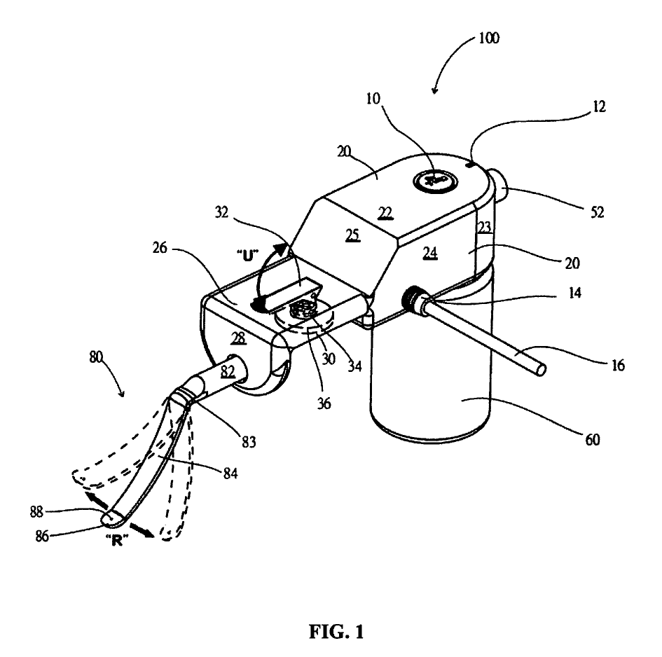

FIG. 1 illustrate one embodiment of a wash and clean system 100, which generally includes a support body 20, an extended element 26 connected to the support body, a lip element 28 connected to the extended element 26, and a spray wand assembly 80 connected to the lip element 28 and adapted to deliver liquids onto a desirable area (e.g., a genital area) of a human body of a user.

The support body 20 of the wash and clean system 100 can be form by one or more parts together into a support enclosure in order to contain therein various fluid channels, electric circuits (e.g., printed circuit boards (PCB)), motors, and combinations thereof, among others. In general, the support body 20 includes an upper portion 22, side walls 24, and a bottom portion (not shown). Optionally, the support body 20 further includes a back wall 23, and a front wall 25.

In one embodiment, the wash and clean system 100 may further includes a power switch 10 such that various motors and electric circuits contained within the support body 20 can be turned on for powering up the apparatus and operating wash, clean and other functions of the apparatus. The power switch 10 can be positioned, in one example, on top of the support body 20, such as on the upper portion 22 and be easily visible to a user. In addition, a power indicator 12 can be positioned on the support body 20 to indicate turning on of the electric power and proper functioning of the wash and clean system 100. In one example, the power indicator 12 can be positioned at or near a side of the upper portion 22 as exemplarily shown in FIG. 1.

In one aspect, the wash and clean system 100 is connected to a power cord 16 via a power connector 14, which is positioned on a part of the support body 20. In one example, the power cord 16 can be positioned at or near a side of the side walls 24 as exemplarily shown in FIG. 1. The power cord 16 is adapted to connected to an electric outlet and provide electric power to power up the wash and clean system 100. In another aspect, the wash and clean system 100 is connected to a battery power pack 70 as shown in FIG. 4 and discussed below in order to conveniently power up the wash and clean system 100 without the need to find an electric outlet.

In another embodiment, the extended element 26 and the lip element 28 of the wash and clean system 100 are adapted to form into an L-shape clamp-like structure so as to be placed and mounted to a rim of a toilet bowl or an edge of a toilet seat. As a result, the wash and clean system 100 can be easily carried around by a user and can be adapted and secured onto a toilet for easy access to the bottom of the person for hygienic cleaning after using the toilet.

In one example, the extended element 26 includes a suction cup assembly 30 therein and a lever 32 on a surface of the extended element 26. The lever 32 is designed to be at an up position or a down position so as to press the suction cup assembly 30 and secure the extended element 26, and thus the whole unit of the wash and clean system 100 onto a rim of a toilet. The suction cup assembly 30 may include a spring 32 and a suction cup 34 being positioned, for example, at the bottom surface portion of the extended element 26, and functioning together to provide a sucking force to a rim portion of a toilet.

As shown in FIG. 1, the spray wand assembly 80 of the wash and clean system 100 includes a distal end element 86 where a spray opening 88 is located. The spray wand assembly 80 further includes one or more liquid channels therein such that the liquids flowing therein can be delivered via the spray opening 88 and sprayed out. For example, the liquids can be sprayed out and onto a desirable area (e.g., a genital area, an anal area, anterior private parts, perianal region, etc.) of a human body while a human is using a toilet.

The spray opening 88 is adapted to spray out liquid in a stream or a mist form onto a desirable area of a human body. The shape and size of the spray opening 88 positioned at the tip of the distal end element 86 is not limited and can be a small opening, a multiple-holed nozzle type element, among others.

Suitable liquid that can be contained and flowed within the one or more channels of the spray wand assembly 80 include water, medication solutions, cleaning solutions and combinations thereof. The temperature of the liquids are not limited and may range from cold water temperature to warm temperature of about 60° C.

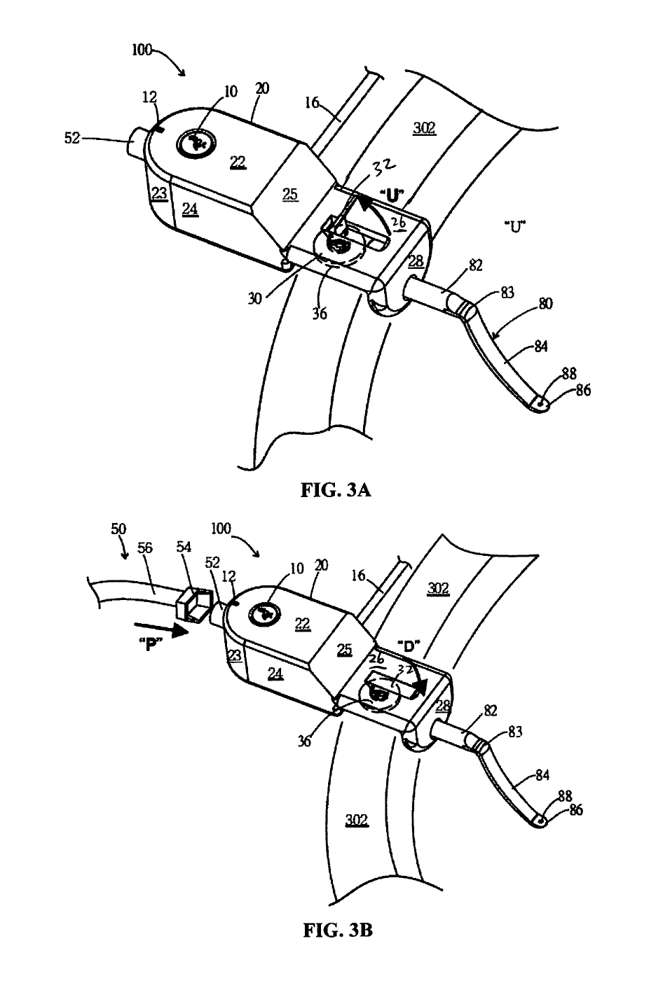

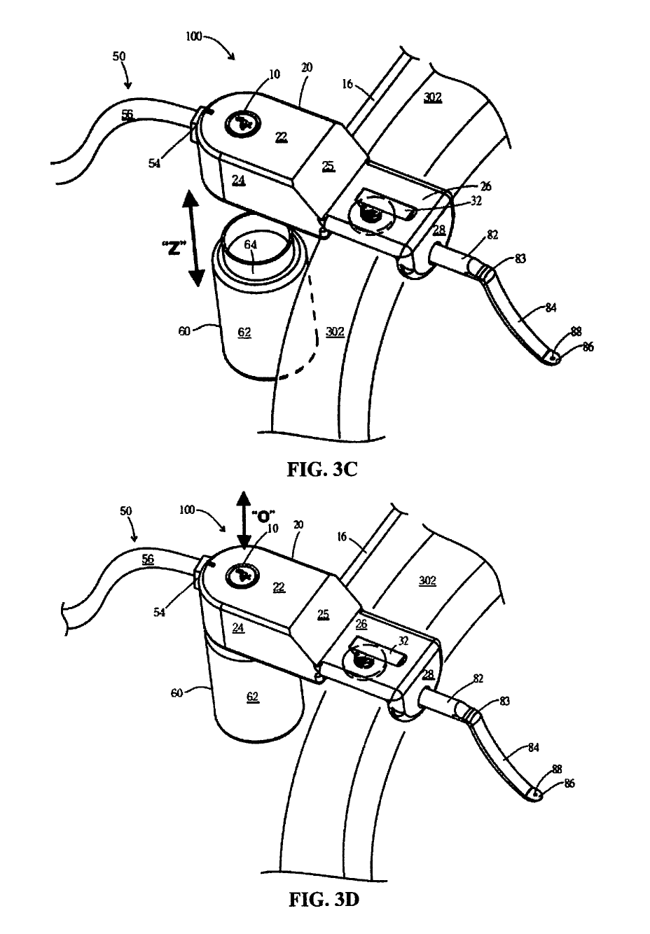

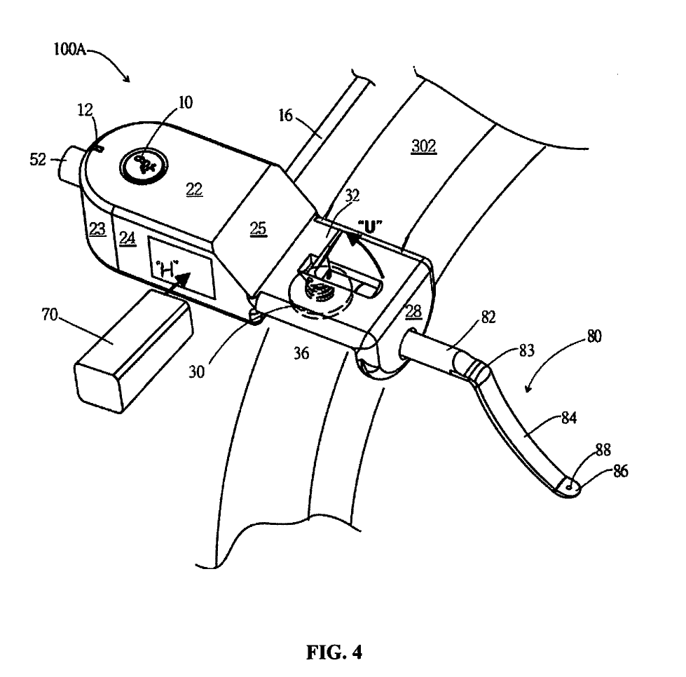

In one embodiment, the support body 20 of the wash and clean system 100 includes a water inlet 52 adapted to connect to a water hose assembly (e.g., a water hose assembly 50 as shown in FIG. 3B) for supplying water and other liquid into the wash and clean system 100. For example, the water inlet 52 can be positioned near the back wall 23 of the support body 20.

In still another embodiment, the support body 20 of the wash and clean system 100 is connected to a canister assembly 60, which may include medication and/or cleaner solutions therein. Suitable medication and cleaning solutions are not limited and can be any of a desirable cleaning solution, a medication solution, a fragrant solution, a deodorant solution, a moisturizing solution, and/or combination thereof. In addition, the content of the liquid solutions within the canister assembly 60 can be changeable according to personal preference of a user or under the instruction of a doctor for treating various perineal or urinary tract infections, vaginal infections, and/or hemorrhoids, among others.

In operation, once the electric power is turned on and the motors within the support body 20 of the wash and clean system 100 are adapted to deliver all desirable liquids (e.g., water and liquid from a water hose assembly via the water inlet 52, a cleaning or medication liquid solution from the canister assembly 60, and combinations thereof) from one or more channels within the support body 20 through the extended elements 26, the lip element 28, to the spray wand assembly 80. The spray wand assembly 80 of the wash and clean system 100 also has one or more fluid channels therein for delivering liquids from the liquid channels within the lip element 28 onto spray opening 88 on the distal end element 86.

As shown in FIG. 1, the spray wand assembly 80 generally includes a connector 83, an arm element 84, and the distal end element 86, where the connector 83 is adapted to rotate the arm element 84 such that the spray opening 88 on the distant end element 86 can be flexibly adjusted to be in close proximity to the desirable area of a human body. In addition, the spray wand assembly 80 further includes a rod element 82, where the connector 83 is adapted to connect the rod element 82 and the arm element 84.

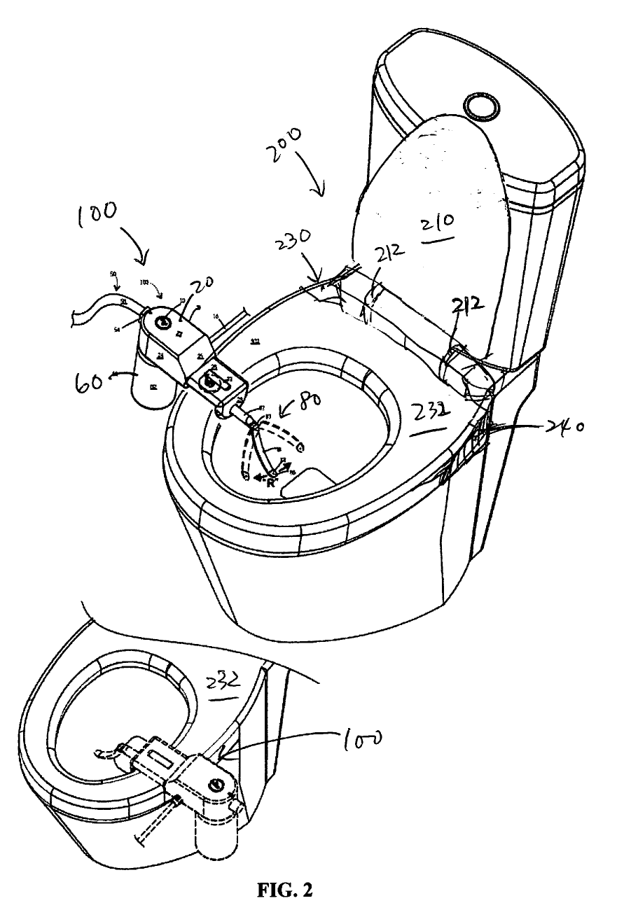

FIG. 2 is one example of the wash and clean system 100 being positioned and secured on a toilet seat apparatus 200 according to one embodiment of the invention. The toilet seat apparatus 200 generally includes a toilet seat cover 210, a toilet set 230, and a sear cover connector 212, connecting the toilet seat cover 210 with the toilet seat 230. In one example, the toilet seat apparatus 200 is a bidet system, which may include a base housing 220 for housing various parts for spray water and other liquids or solutions to clean a perianal area of a user using the toilet seat system.

Because most bidet systems has water spray nozzle coming out from the base housing system 220 to clean a posterior portion (e.g., anal or perianal regions, etc.) of a human body, it is desirable to position a wash and clean system of the invention, such as the example of the wash and clean system 100 onto the toilet seat apparatus 200 to clean the anterior or front area of a user, especially the private parts or vaginal area of a female or a person (male or female) who has a urinary tract infection and need to wash and apply a medication solution onto an anterior private-part region. Alternatively, the wash and clean system 100 of the invention can be positioned and mounted to a conventional toilet seat without a pre-installed bidet system.

FIGS. 3A-3D illustrate a method of operating the wash and clean system 100 according to one or more embodiments of the invention. As shown in FIG. 3A, the wash and clean system 100 of the invention can initially be positioned and mounted to a seat rim 302 of a toilet seat. Then, a user (e.g., a female or male human being) can lift up the lever 20 in a direction marked as “U” so as to adjustably apply sufficient tension to the spring 34 and suction cup 36 of the suction cup assembly 30.

As shown in FIG. 3B, the user can next push down the lever 20 in a direction marked as “D” so as to compress the spring 34 and suction cup 36 of the suction cup assembly 30 and secure the wash and clean system 100 onto a portion of the seat rim 302. In addition, the user can easily attach the water hose assembly 50 in a direction “P” onto the water inlet 52 of the wash and clean system 100 for supplying water to the channels within the support body 20 of the wash and clean system 100. The water hose assembly 50 may include a water hose head 54, which may optionally includes an on-off valve, and a long water hose 56 connected to a tap water outlet or other water source.

Next, optionally, the user can choose to supply additional liquid solutions (in addition to the water liquid provided from a water source from the water inlet 52) to the wash and clean system 100 by connecting the canister assembly 60 onto the support body 20 of the wash and clean system 100. For example, a user may hold the canister assembly 60 in an upright position with a liquid solution contained therein and move the canister assembly 60 in a direction “Z” to connect and secure the canister assembly 60 onto the support body 20.

As shown in FIG. 3C, the canister assembly 60 may include a canister body 62 and a canister top 64. The canister top may be formed into a screw-like shape to be able to turned and secured onto a bottom portion (not shown) of the support body 20. In one aspect, the canister body 62 of the canister assembly 60 is made of an insulation material so as to insulate and maintain the temperature of a liquid solution contained therein. Suitable insulation materials include stainless, plastics and other materials.

FIG. 3D is a front view of operating the wash and clean system 100 according to one embodiment of the invention. As shown in FIG. 3D, once the wash and clean system 100 is secured and all necessary parts are properly connected to auxiliary assemblies (e.g., the power cord 16, water hose assembly 50, the canister assembly 60, the user may turn on the electric power of the wash and clean system 100 by pushing the power switch 10, for example, in a direction “O” and start to operate and use the wash and clean system. The power switch 10 of the wash and clean system 100 may be controlled by electric circuits contained within the support body 20 and adapted to operate the flow of the liquids within the liquid channels of the wash and clean system 100 and spray liquids out of the spray opening 88 of the spray wand assembly 80.

Returning back to FIG. 1, during the operation of the wash and clean system by a user, the arm element 84 of the spray wand assembly 80 can be flexibly turned and/or rotated in a direction “T” by a user to a desirable “L” position or alternatively “R” position. Accordingly, the user is able to adjust the position of the arm element 84, thereby adjusting the spraying direction of the liquid sprayed out of the spray opening 88 so as to better wash and clean a specific area desirable to the user.

FIG. 4 shows a perspective view of the wash and clean system 100A that includes the battery power pack 70, thereby making the wash and clean system much more convenient and easy to be compatible to various toilet systems, without the need of a electric outlet nearby. A portable battery, such as the battery power pack 70 coupled to a side or a portion of the support body 20 can be used to provide electric power to turn on motors within wash and clean system 100A and deliver liquids therein to the distal end element and spray liquids out of the spray opening 88.

Accordingly, a method and apparatus that is easy to carry, easy to be connected to auxiliary parts, and easy to install and use is provided for washing and cleaning a region of a human body. While the foregoing is directed to embodiments of the present invention, other and further embodiments of the invention may be devised without departing from the basic scope thereof, and the scope thereof is determined by the claims that follow.

1. An apparatus for washing and cleaning a region of a human body, comprising:
a support body;
an extended element connected to the support body;
a lip element connected to the extended element; and
a spray wand assembly connected to the lip element and adapted to deliver liquid with one or more liquid channels therein, wherein the spray wand assembly includes a distal end element where a spray opening is located.

2. The apparatus of claim 1, further comprising a power switch.

3. The apparatus of claim 1, further comprising a power indicator.

4. The apparatus of claim 1, wherein the support body comprises a water inlet that is adapted to be connected to a water hose assembly.

5. The apparatus of claim 1, wherein the support body is connected to a power cord.

6. The apparatus of claim 1, wherein the support body is connected to a battery power pack.

7. The apparatus of claim 1, wherein the support body is connected to a canister assembly.

8. The apparatus of claim 1, wherein the extended element comprises a lever.

9. The apparatus of claim 1, wherein the extended element comprises a suction cup assembly therein.

10. The apparatus of claim 1, wherein the spray wand assembly comprises an arm element and a connector, wherein the connector is adapted to rotate the arm element.

11. The apparatus of claim 10, wherein the spray wand assembly further comprises a rod element, wherein the connector is adapted to connect the rod element and the arm element.

12. The apparatus of claim 10, wherein the arm element of the spray wand assembly is connected to the distal end element.

13. An apparatus for washing and cleaning a region of a human body, comprising:
a support body;
an extended element connected to the support body;
a lip element connected to the extended element;
a spray wand assembly connected to the lip element and adapted to deliver liquid with one or more liquid channels therein, wherein the spray wand assembly includes a distal end element where a spray opening is located;
a power switch; and
a power indicator.

14. The apparatus of claim 13, wherein the support body comprises a water inlet that is adapted to be connected to a water hose assembly.

15. The apparatus of claim 13, wherein the extended element comprises a lever and a suction cup assembly therein.

16. The apparatus of claim 13, wherein the spray wand assembly comprises an arm element, a rod element, and a connector, wherein the connector is adapted to rotate the arm element, and connect the rod element and the arm element.

17. The apparatus of claim 1, wherein the support body is connected to a power mechanism.

18. The apparatus of claim 1, wherein the support body is connected to a canister assembly with medication or cleaner solutions therein.

19. The apparatus of claim 1, wherein the support body comprises a water inlet adapted to be connected to a water hose assembly for supplying water and other liquid into the apparatus.

20. An apparatus for washing and cleaning a region of a human body, comprising:
a support body, wherein the support body comprises a water inlet that is adapted to be connected to a water hose assembly;
an extended element connected to the support body;
a lip element connected to the extended element; and
a spray wand assembly connected to the lip element and adapted to deliver liquid with one or more liquid channels therein, wherein the spray wand assembly includes a distal end element where a spray opening is located.
